(19) United States
(12) Patent Application Publication
(10) Pub. No.: US 2006/0192539 A1
(43) Pub. Date: Aug. 31, 2006

(54) Switching regulator control circuit and switching regulator

(76) Inventors: Yutaka Sato, Chiba-shi (JP); Takao Nakashino, Chiba-shi (JP)

Correspondence Address: BRUCE L. ADAMS, ESQ., SUITE 1231, 17 BATTERY PLACE, NEW YORK, NY, 10004, US

(21) Appl. No.: 11/360,211

(22) Filed: Feb. 23, 2006

(30) Foreign Application Priority Data
Feb. 25, 2005 (JP) 2005-051195

(51) Int. Cl. G05F 1/40; G05F 1/618

(52) U.S. Cl. 323/282

(57) ABSTRACT

A switching regulator in which a ceramic capacitor is used as an output capacitor is provided to secure a stable operation in a control loop system. A phase compensation circuit capable of forming a zero point is inserted between a differential pair of an error amplifier in the control loop system, thereby securing the stable operation in the control loop system.

### BACKGROUND OF THE INVENTION

1. Field of the Invention

The present invention relates to a switching regulator, and more particularly to a switching regulator control circuit provided with a phase compensation circuit for stabilizing an output voltage.

2. Description of the Related Art

FIG. 6 shows a circuit structure of a conventional switching regulator. A stable operation of the switching regulator cannot be secured unless phase compensation is performed in a control loop system for stabilizing an output voltage. Considered are, for example, stabilization conditions of open loop gain measured at the input side of an error amplifier 605, and of a phase characteristic. Phase delay of the control loop system needs to be suppressed to 180 degrees or less by using a pole for delaying a phase and a zero point for returning the phase when the open loop gain of the control loop system is 1 or more. In the conventional switching regulator shown in FIG. 6, voltage dividing resisters R1 and R2 that divide an output voltage and a capacitor Cfb form the zero point for returning the phase, which suppresses the phase delay of the control loop system to 180 degrees or less (refer to JP 07-274495 A (page 2)).

FIG. 7 is a Bode diagram showing the gain and the phase characteristic of the control loop system in the conventional switching regulator. Gain 701 and phase characteristic 702 of the control loop system are determined mainly by a coil L and an output capacitor Cout. In this case, the gain lowers at 40 dB/dec with a frequency fp1 expressed by Expression 1 as a starting point. Also, the phase delays by about 90 degrees at the frequency fp1.
Frequency fp1=1/2π\sqrt{L−Cout} (Expression 1)

Here, unless the phase delay of the control loop system is suppressed, the phase delay of 180 degrees at the maximum occurs at a frequency exceeding the frequency fp1. As a result, a stable output voltage cannot be obtained.

In view of this, in the conventional switching regulator shown in FIG. 6, the voltage dividing resisters R1 and R2 that divide an output voltage and the capacitor Cfb form the zero point for returning the phase. This suppresses the delay of the phase 702 of the control loop system by 180 degrees when the open loop gain 701 of the control loop system is 1 or more. The zero point at this time corresponds to a frequency f01. The phase is returned by 45 degrees at the frequency f01. Further, the phase is returned by 90 degrees at the maximum at the frequency exceeding the frequency f01.
Frequency f01=1/2π−Cfb−R1 (Expression 2)

Further, the voltage dividing resisters R1 and R2 and the capacitor Cfb have a pole at a frequency fp2, which is larger than the frequency f01 and is expressed by Expression 3. At the frequency fp2, the phase delay of 45 degrees is caused with the frequency f01 as a starting point. Further, the phase delay of 180 degrees at the maximum occurs at the frequency exceeding the frequency fp2.
Frequency fp2=(R1+R2)/2πCfb−R1−R2 (Expression 3)

In general, an index of a stable operation of the control loop system, which indicates phase delay at an open loop gain of 1 and is called a phase margin, is widely used. The related power supply circuit does not operate stably unless a phase margin of 45 degrees or more is secured. Thus, it is difficult that only the zero point, which is formed by the voltage dividing resisters R1 and R2 and the capacitor Cfb, secure the phase margin of 45 degrees or more. Therefore, the output capacitor Cout and a resistor Resr, which is inserted in series with respect to the output capacitor Cout, are used to form another zero point. The zero point at this time corresponds to a frequency f02 expressed by Expression 4. The phase delay of 45 degrees is returned at the frequency f02. Further, the phase is returned by 90 degrees at the maximum at the frequency exceeding the frequency f02.

Frequency f02=1/2π−Cout−Resr (Expression 4)

That is, phase compensation is performed at the zero points of the frequency f01 and the frequency f02, as shown in FIG. 7, thereby securing the stable operation of the control loop system. Particularly at the frequency f02, in the case of the output capacitor composed of a tantalum capacitor, the resistor Resr is built into the capacitor itself. Thus, it is characteristic that phase compensation be performed easily without addition of components.

However, it is known that, when the tantalum capacitor is destructed, terminals at both the sides of the tantalum capacitor are brought into a short-circuit state. When the tantalum capacitor as the output capacitor is destructed, an output thereof is short-circuited with VSS, which causes a large current to flow. This may cause heat generation that results in ignition. Therefore, in recent years, a ceramic capacitor, whose terminals at both the sides are brought into an open state at the time of breakdown, has been used often as the output capacitor.

However, in the case where the ceramic capacitor is used as the output capacitor, the Resr is extremely small. Thus, the zero point of the frequency f02, which exists in the tantalum capacitor, does not exist. That is, there arises a problem in that phase compensation is not performed at the frequency f02. FIG. 8 is a Bode diagram showing gain and phase characteristic of the control loop system at this point. In FIG. 8 compared with FIG. 7, the phase is returned by only 45 degrees at the frequency f01 because the frequency f02 does not exist. Thus, the phase margin of 45 degrees cannot be secured, which makes it difficult to secure a stable operation. In addition, the number of components increases when the resistor Resr is used as an external component. Therefore, an increase in costs is caused when the entire switching regulator is considered.

### SUMMARY OF THE INVENTION

The present invention has been made in order to solve the above-described problems, and therefore has an object to provide a switching regulator in which a ceramic capacitor is used as an output capacitor. The switching regulator has a structure in which a phase compensation circuit capable of forming a zero point is inserted between a differential pair of an error amplifier in a control loop system to secure a stable operation in the control loop system.

The switching regulator, in which the ceramic capacitor is used as the output capacitor, is structured as described above. Therefore, the switching regulator capable of securing the stable operation in the control loop system can be provided without addition of a resistor as a component for output.

### BRIEF DESCRIPTION OF THE DRAWINGS

In the accompanying drawings:

FIG. 1 is a circuit diagram of a differential pair of an error amplifier in a switching regulator according to the present invention;

FIG. 2 is a circuit diagram of a differential pair of an error amplifier in a switching regulator according to Embodiment 1 of the present invention;

FIG. 3 is a Bode diagram showing gain and phase characteristic of a control loop system and gain of the error amplifier in the switching regulator according to Embodiment 1 of the present invention;

FIG. 4 is a circuit diagram of a differential pair of an error amplifier in a switching regulator according to Embodiment 2 of the present invention;

FIG. 5 is a Bode diagram showing gain and phase characteristic of a control loop system and gain of the error amplifier in the switching regulator according to Embodiment 2 of the present invention;

FIG. 6 is a circuit diagram of a conventional switching regulator;

FIG. 7 is a Bode diagram showing gain and phase characteristic of a control loop system in the case of the conventional switching regulator including Resr; and

FIG. 8 is a Bode diagram showing gain and phase characteristic of the control loop system in the case of the conventional switching regulator not including Resr.

### DETAILED DESCRIPTION OF THE PREFERRED EMBODIMENTS

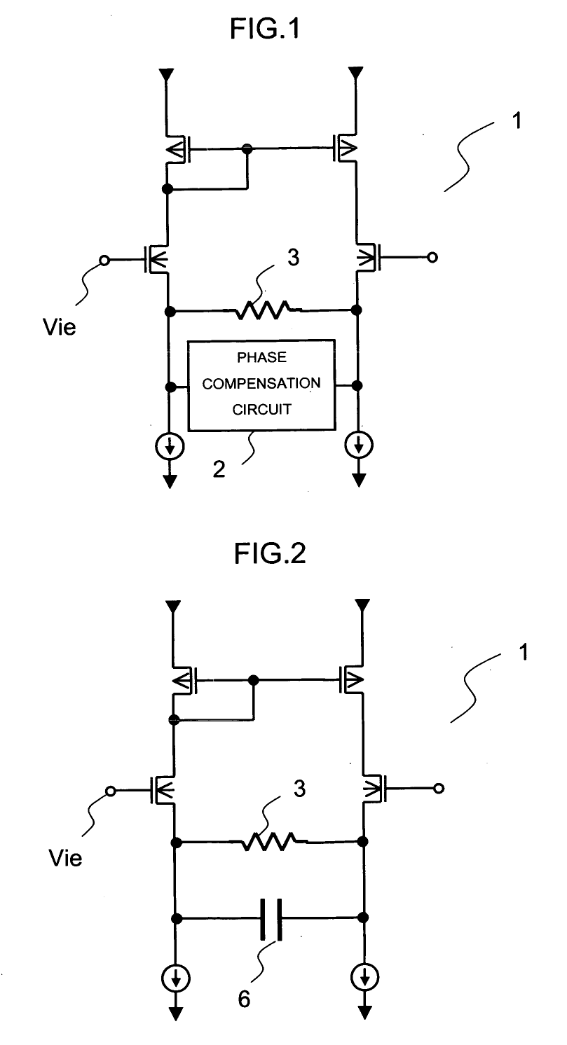

FIG. 1 is a circuit diagram of a differential pair of an error amplifier in a switching regulator according to the present invention. A differential pair 1 of the error amplifier is provided with a phase compensation circuit 2 inserted so as to be in parallel with a resistor 3. The phase compensation circuit capable of forming a zero point is provided between the differential pair of the error amplifier in a control loop system, with the result that a stable operation can be secured without addition of a resistor for output. Hereinafter, description will be made of embodiments of the present invention with reference to a specific circuit of the phase compensation circuit 2 and Bode diagrams.

### Embodiment 1

FIG. 2 is a circuit diagram of a differential pair of an error amplifier in a switching regulator according to Embodiment 1 of the present invention. The differential pair 1 of the error amplifier is provided with a capacitor 6, which is inserted in parallel with the resistor 3, serving as a phase compensation circuit.

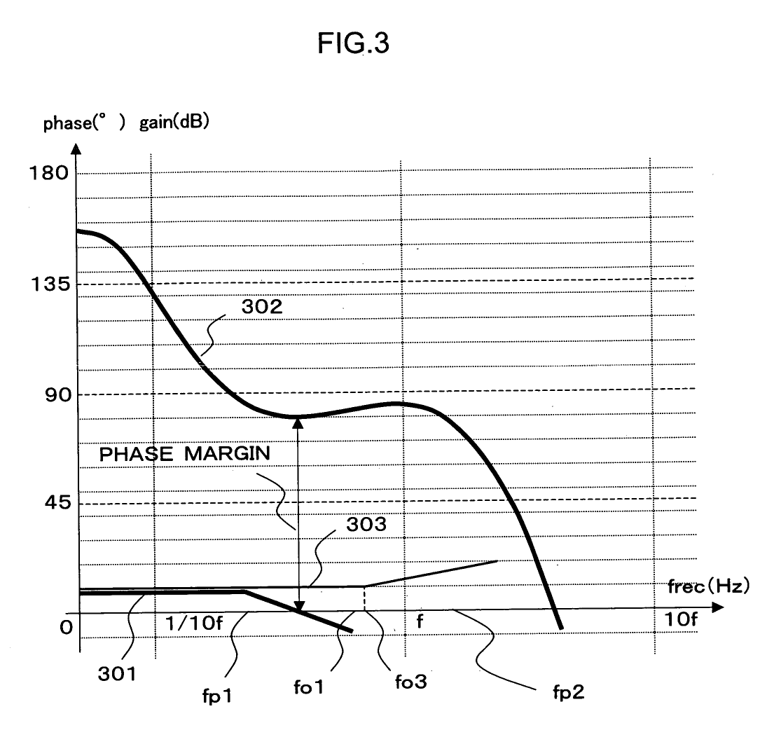

FIG. 3 is a Bode diagram showing gain and phase characteristic of a control loop system of the switching regulator according to Embodiment 1 of the present invention. The Bode diagram shows gain 301 and a phase characteristic 302 of the control loop system and gain 303 of the error amplifier as a single component. A zero point f03 is formed by using the phase compensation circuit, which is built into the error amplifier, in the same frequency band as that of the zero point f02, which has been conventionally formed by using an output capacitor Cout and a resistor Resr inserted in series with respect to the output capacitor Cout. As a result, a stable operation in the control loop system is secured with the same effect as that with the zero point f02. Further, the gain increases at 20 dB/dec from the zero point f03 due to the zero-point characteristic. Thus, a transient characteristic of the error amplifier is also enhanced in a high frequency region. When a capacitance value of the capacitor 6 is represented by Cerr, a frequency of the zero point f03 is expressed by Expression 5.
Frequency f03=1/2π−Cerr−Re (Expression 5)

The zero point f03 is set through adjustment of the capacitance value Cerr so as to have the same frequency band as that of the zero point f02, which has been conventionally formed by using the conventional output capacitor Cout and the resistor Resr inserted in series with respect to the output capacitor Cout. Accordingly, the stable operation in the control loop system can be easily secured even with a ceramic capacitor not including the resistor Resr.

### Embodiment 2

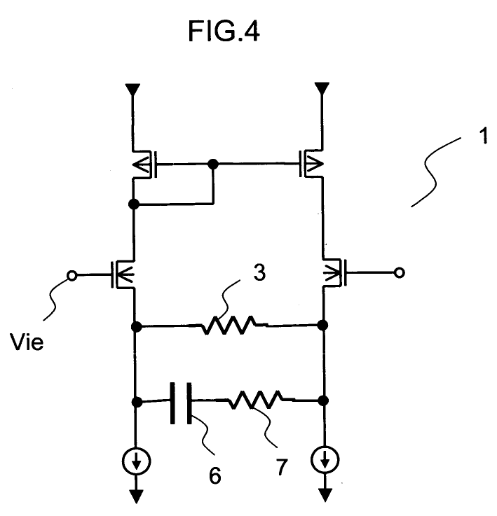

FIG. 4 is a circuit diagram of a differential pair of an error amplifier in a switching regulator according to Embodiment 2 of the present invention. The differential pair 1 of the error amplifier is provided with the capacitor 6 and a resistor 7, which are connected in series to serve as a phase compensation circuit and which are inserted in parallel with the resistor 3.

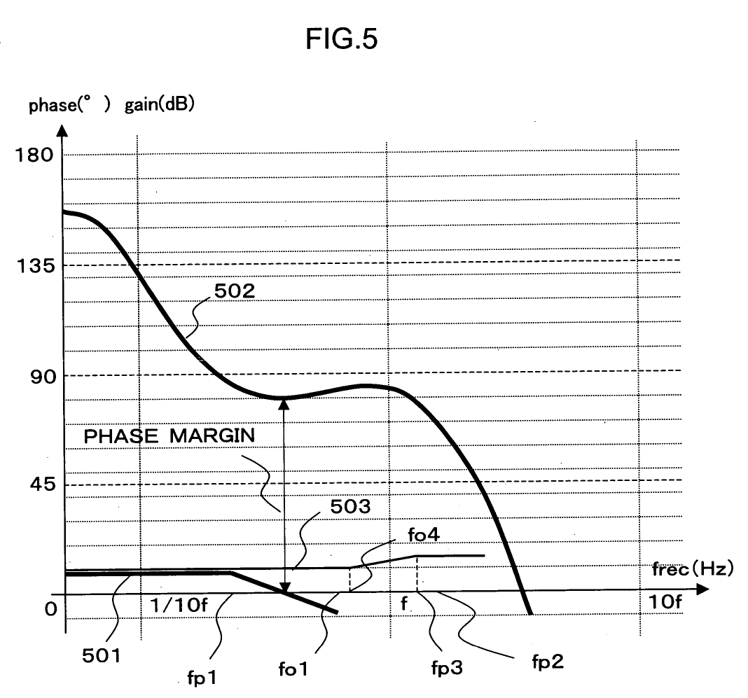

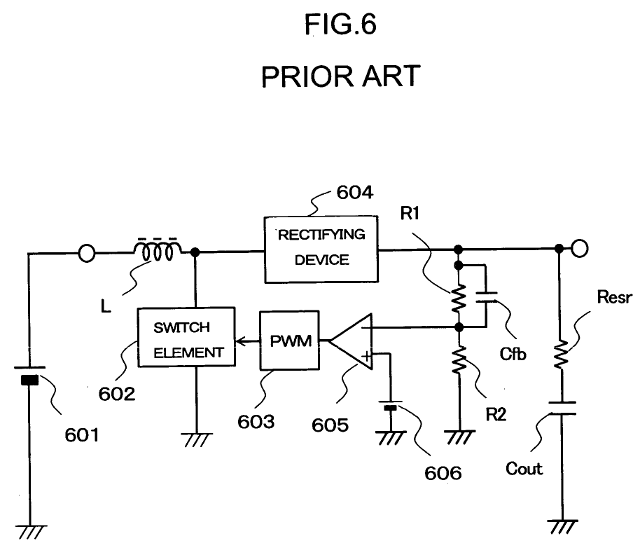

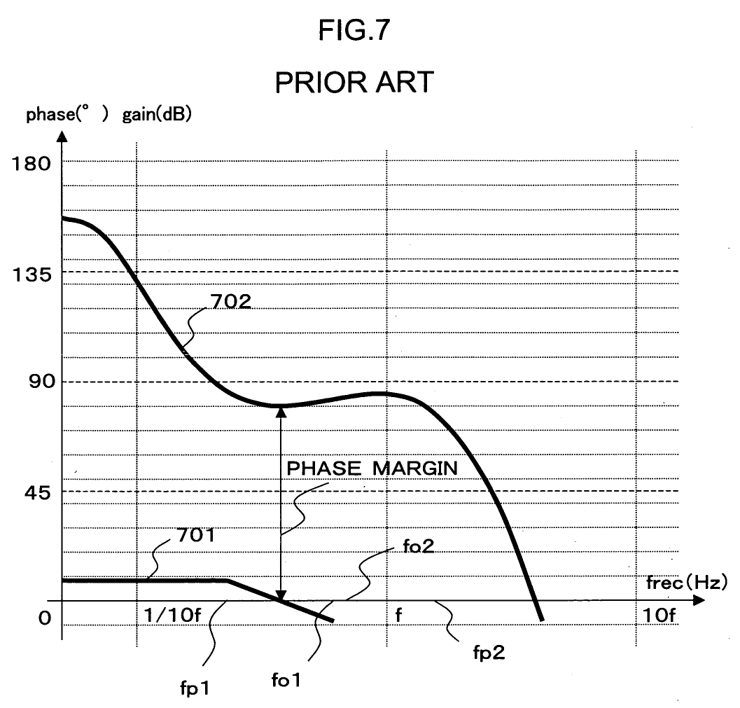

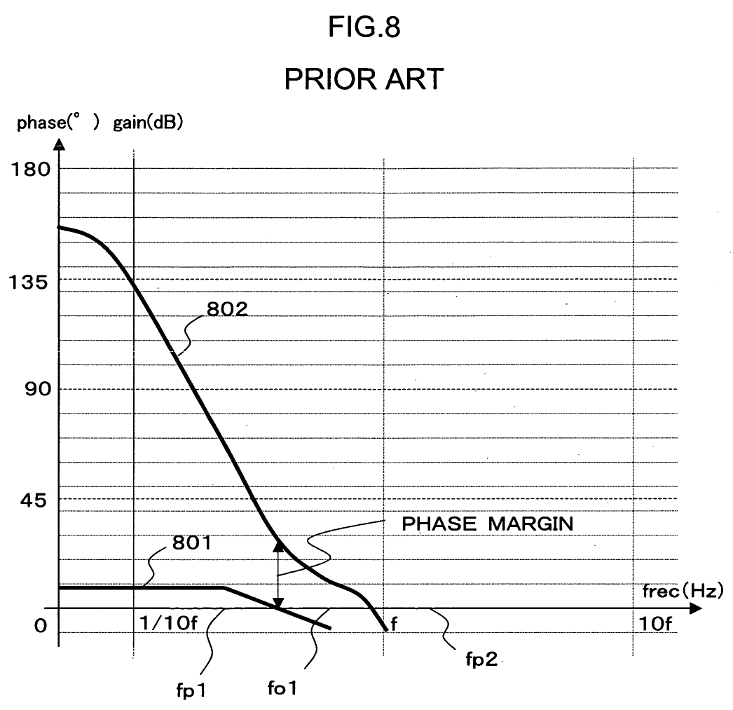

FIG. 5 is a Bode diagram showing gain and phase characteristic of a control loop system in the switching regulator according to Embodiment 2 of the present invention. The Bode diagram shows gain 501 and a phase characteristic 502 of the control loop system and gain 503 of the error amplifier as a single component. At this time, a frequency of a zero point f04 and a frequency of a pole fp3 are expressed by Expressions 6 and 7, respectively.
Frequency f04=1/2πCerr−(Rerr+Re) (Expression 6)
Frequency fp3=1/2π−Cerr−Rerr (Expression 7)

Accordingly, Cerr and Rerr are adjusted, thereby securing the stable operation in the control loop system with the same mechanism as explained in Embodiment 1, in which the zero point is formed in the same frequency band as that of the zero point f02.

Moreover, a frequency fp3 exceeding the zero point f04 is made to have a pole to obtain constant gain at the pole fp3, thereby being capable of controlling the transient characteristic of the error amplifier in the high frequency region.

What is claimed is:

1. A switching regulator control circuit for controlling a switching pulse for boosting an input voltage, comprising:
an error amplifier for comparing a divided voltage which is obtained by dividing an output voltage with a voltage dividing resistor with a reference voltage; and
a phase compensation circuit inserted between a differential pair of the error amplifier.

2. A switching regulator control circuit according to claim 1, wherein the phase compensation circuit comprises a capacitor.

3. A switching regulator control circuit according to claim 1, wherein the phase compensation circuit comprises a capacitor and a resistor which are connected in series.

4. A switching regulator, comprising the switching regulator control circuit according to claim 1.
